(19) United States
(12) Patent Application Publication
(10) Pub. No.: US 2013/0049490 A1
(43) Pub. Date: Feb. 28, 2013

(54) MAGNETIC PLATE HAVING WOVEN CLOTH, LINEAR MOTOR HAVING THE MAGNETIC PLATE, AND METHOD OF MANUFACTURING THE MAGNETIC PLATE

(71) Applicants: Yoshifumi Shimura, Minamitsuru-gun (JP); Takuya Maeda, Minamitsuru-gun (JP); Yuusuke Kondou, Minamitsuru-gun (JP)

(72) Inventors: Yoshifumi Shimura, Minamitsuru-gun (JP); Takuya Maeda, Minamitsuru-gun (JP); Yuusuke Kondou, Minamitsuru-gun (JP)

(73) Assignee: FANUC Corporation, Minamitsuru-gun (JP)

(21) Appl. No.: 13/564,955

(22) Filed: Aug. 2, 2012

(30) Foreign Application Priority Data
Aug. 25, 2011 (JP) 2011-183617

(51) Int. Cl. H02K 1/06

(52) U.S. Cl. 310/12.24

(57) ABSTRACT

A magnetic plate for a linear motor, a linear motor having the magnetic plate, and a method of manufacturing the magnetic plate, wherein the strength of a portion where the thickness of a resin layer is small is improved, while maintaining desired thrust force of the motor. A woven cloth such as a glass woven cloth or a carbon fiber woven cloth is attached on a surface of a plurality of permanent magnets, wherein N-poles and S-poles of the permanent magnets are alternately positioned. Then, a resin protecting layer is formed on the woven cloth by resin molding.

### BACKGROUND OF THE INVENTION

1. Field of the Invention

The present invention relates to a linear motor, for example used for driving a movable part of a machine tool, a magnetic plate for the linear motor, and a method of manufacturing the magnetic plate.

2. Description of the Related Art

In order to drive a movable part of a machine tool, for example, a linear motor including permanent magnets and an armature core are often used, wherein N-poles and S-poles of the permanent magnets are alternately arranged and the armature core is movably supported relative to the permanent magnets. For example, Japanese Unexamined Patent Publication (Kokai) No. 10-52025 discloses a linear motor of a permanent magnet synchronization type, including a pair or armatures 11, 12 and a fixed magnetic plate 15 between the pair of armatures, wherein a magnet piece (permanent magnets 13, 15) are arranged at the both ends of magnetic plate 15 and armatures 11, 12 are integrally moved. In this linear motor, uneven thrust force of the linear motor is reduced by offsetting a phase in a direction so that two uneven thrust forces generated at the both ends of the magnetic plate can be balanced out.

Japanese Unexamined Patent Publication (Kokai) No. 5-111234 discloses a core coil assembly of a linear motor and a manufacturing method thereof, wherein glass fiber is positioned on an inner bottom surface of a mold, a core coil assembly is fitted into the mold, and then epoxy resin is injected so as to form a core coil assembly having a fiber reinforced plastic (FRP) layer in a gap on surface of the core.

Generally, in a liner motor, thrust force is increased as a gap between an iron core at the coil side and a magnet at the magnetic plate side is decreased. Therefore, it is advantageous to reduce the thickness of a resin layer formed on magnet surface for protecting the magnet. However, when thickness of the resin layer is decreased, the strength of the motor is deteriorated. In the prior art, any approach for obtaining sufficient thrust force and strength has not been proposed.

### SUMMARY OF THE INVENTION

The object of the present invention is to provide a magnetic plate for a linear motor, a linear motor having the magnetic plate, and a method of manufacturing the magnetic plate, wherein the strength of a portion where the thickness of a resin layer is small is improved, while maintaining desired thrust force of the motor.

One aspect of the present invention provides a magnetic plate for a linear motor having permanent magnets constituted by a plurality of pole pairs, the magnetic plate cooperating with an armature having an iron core and a winding wire to form a linear motor, the armature being movable relative to the magnetic plate; wherein the magnetic plate comprises a resin layer positioned between a surface of the permanent magnet and the armature and on the surface of the permanent magnet; and wherein a woven cloth, with which resin is impregnated, is arranged between the surface of the permanent magnet and the resin layer, so that the woven cloth covers the surface of the permanent magnet.

In a preferred embodiment of the magnetic plate, the woven cloth is a glass woven cloth or a carbon fiber woven cloth.

In a preferred embodiment of the magnetic plate, the resin is epoxy resin or phenol resin.

In a preferred embodiment of the magnetic plate, each permanent magnet is a rectangular parallelepiped; or, a curve shape obtained by two-dimensionally projecting a surface of each permanent magnet opposed to the armature, in a direction perpendicular to an array direction of the permanent magnets, is represented by a quadric curve, an arc or a hyperbolic cosine function.

In a preferred embodiment of the magnetic plate, a distance between an upper portion of the surface of the permanent magnet and a surface of the resin layer is equal to or less than 1 mm.

In a preferred embodiment of the magnetic plate, a distance between an upper portion of the surface of the permanent magnet and a surface of the resin layer is equal to or less than a distance between adjacent magnets of N-pole and S-pole.

In a preferred embodiment of the magnetic plate, the plurality of pole pairs of permanent magnets are arrayed on one iron plate so as to constitute a set of permanent field poles, and a plurality of sets of permanent field poles are arrayed in a row so as to constitute a magnetic plate for a linear motor.

The present invention further provides a linear motor comprising the magnetic plate as described above.

Another aspect of the present invention provides a method of manufacturing a magnetic plate for a linear motor, having permanent magnets constituted by a plurality of pole pairs, the magnetic plate cooperating with an armature having an iron core and a winding wire to form a linear motor, the armature being movable relative to the magnetic plate; wherein the magnetic plate comprises a resin layer positioned between a surface of the permanent magnet and the armature and on the surface of the permanent magnet; the method comprising the steps of: arranging a woven cloth between a surface of the resin layer opposed to the armature and the permanent magnet by covering the surface of the permanent magnet with the woven cloth; positioning the permanent magnet in a mold; and carrying out resin molding to form the resin layer by injecting resin on the woven cloth so that the injected resin is impregnated with the woven cloth.

In a preferred embodiment of the method, the woven cloth is adhered to the surface of the permanent magnet when the woven cloth covers the surface of the permanent magnet.

In a preferred embodiment of the method, the resin is injected from a center point of a permanent field pole in relation to an arraying direction of the permanent magnets.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 shows a schematic configuration of a linear motor according to one first embodiment of the invention;

FIG. 2 shows a state wherein a magnetic plate of FIG. 1 is covered by a woven cloth;

FIG. 3 shows a state wherein resin molding is carried out for the magnetic plate of FIG. 2;

FIG. 4 shows a preferable resin injection point for the magnetic plate; and

FIG. 5 is a graph representing the relationship between thrust force of the motor and a distance between an upper portion of a surface of the magnetic plate and a surface of resin.

### DETAILED DESCRIPTION

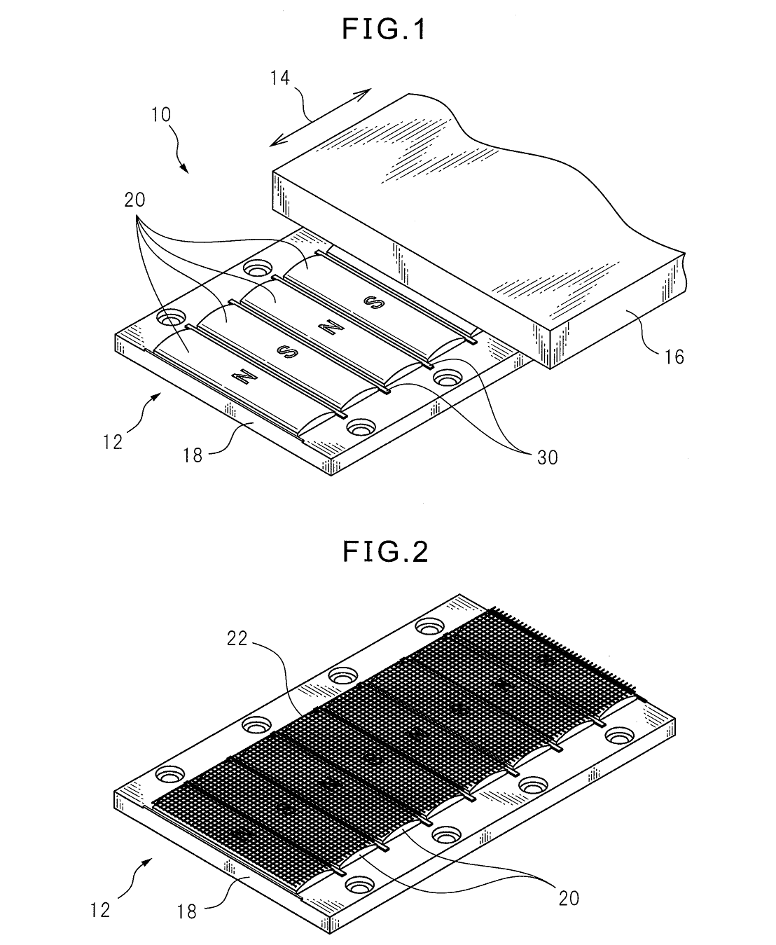

FIG. 1 shows a schematic configuration of a linear motor 10 according to the present invention. Linear motor 10 has a magnetic plate for the linear motor 12 which serves as a fixed magnetic field generating means, and an armature 16 configured to be movable relative to magnetic plate 12 in an axial direction (indicated by an arrow 14), wherein magnetic plate 12 and armature 16 cooperatively constitute linear motor 10. In detail, magnetic plate 12 has an iron plate (yoke) 18, a plurality of permanent magnets 20 wherein N-poles and S-poles of the permanent magnets are alternately positioned on iron plate 18 along the axial direction, a woven cloth as described below, and a resin layer (not shown).

Schematically illustrated armature 16 has an iron core and a winding wire, and serves as a movable magnetic field generating means. In linear motor 10, similarly to the conventional linear motor, armature 16 may be moved relative to magnetic plate 12, due to interaction between a fixed magnetic field generated by magnetic plate 12 (or permanent magnet 20) and a movable magnetic field generated by the movable magnetic field generating means (or armature 16).

As the shape of each permanent magnet 20, for example, a flat plate (or rectangular parallelepiped) may be used. Alternatively, as shown, each permanent magnet may be a plate having a curved surface opposed to armature 16, by which the thickness of each permanent magnet is gradually decreased toward adjacent permanent magnet. As concrete examples for the curved surface, a curve obtained by two-dimensionally projecting the curved surface of each permanent magnet in a direction perpendicular to an array direction of the permanent magnets, is represented by a quadric curve, an arc or a hyperbolic cosine function. When each permanent magnet 20 is formed as the rectangular parallelepiped, the production of the permanent magnet can be facilitated and the production cost thereof can be reduced. On the other hand, when each permanent magnet 20 has the curved surface, armature 16 may be smoothly moved relative to magnetic plate 12 in the linear motor.

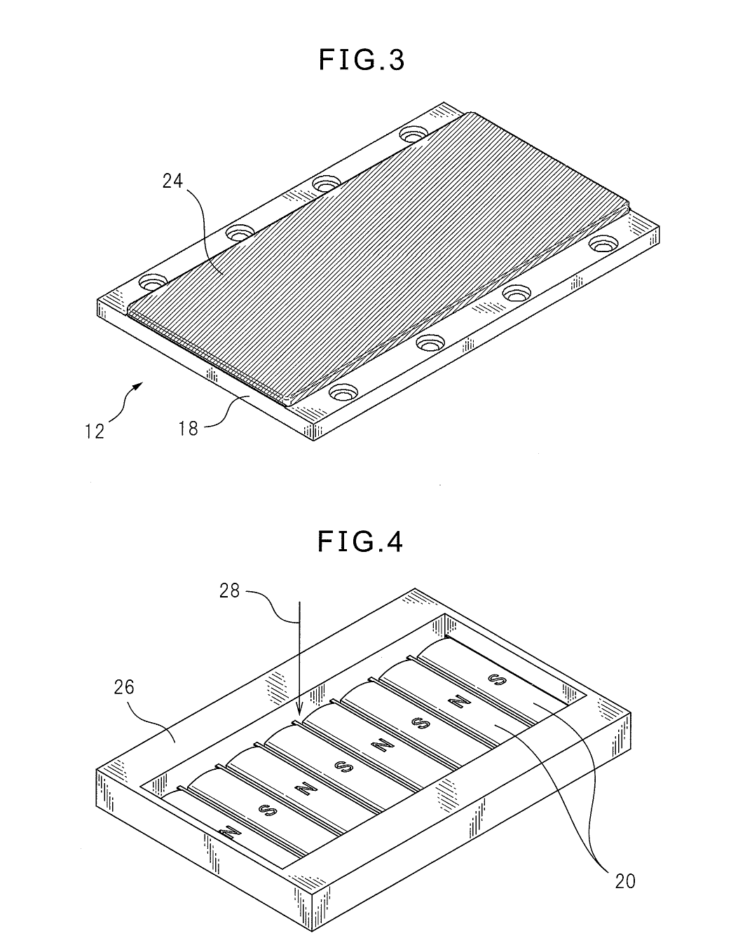

FIG. 2 shows a production process of magnetic plate 12. In the invention, on a surface (upper surface) of permanent magnets 20 wherein N-poles and S-poles are alternately positioned, a woven cloth 22 such as a glass woven cloth or a carbon fiber woven cloth is attached. Then, as shown in FIG. 3, a resin protecting layer 24 is formed on woven cloth 22 by resin molding. In detail, in a set of permanent field poles having a plurality of pole pairs, the surface of permanent magnet 20 is covered by woven cloth 22, and woven cloth 22 is positioned between resin protecting layer 24 opposed to armature 16 and permanent magnets 20. In addition, in order to prevent that a crinkle is formed in woven cloth 22 by injecting resin, woven cloth 22 may be adhered to the surface of permanent magnets 20 by using adhesives or the like.

By virtue of the above feature, woven cloth 22 may be impregnated with resin when resin molding as described below, and resin may be uniformly spread over the surface of permanent magnet 20 without mixing air bubbles into resin. Further, the strength of the resin layer can be improved by using the woven cloth, and thus the desired strength may be obtained even if the resin layer is relatively thin so as to obtain required thrust force of the motor.

FIG. 4 shows a concrete process for forming the resin layer by resin molding. As shown in FIG. 4, by using a mold 26 having an opening, an area of which is generally the same as a surface are of a set of permanent field poles (eight or four pairs of permanent magnets 20 in the drawing) having a plurality of (four in the drawing) pole pairs, resin is injected so that a resin layer is formed the woven cloth (not shown) on permanent magnets 20. In this regard, when an injection point where resin is injected is determined at a generally center of the permanent field poles in relation to an array direction of permanent magnets 20 (i.e., a moving direction of the armature), as indicated by an arrow 28 in FIG. 3, the injected resin can flow in mold 26 without mixing air bubbles into the resin. Therefore, it is unlikely that air bubbles are formed on the surface of the woven cloth, and a preferable resin molding can be carried out, whereby resin layer 24 having a flat surface and uniform thickness can be obtained.

Various type of resin may be used for forming resin layer 24, in particular, epoxy resin or phenol resin is preferable, in view of heat resistance and/or formability.

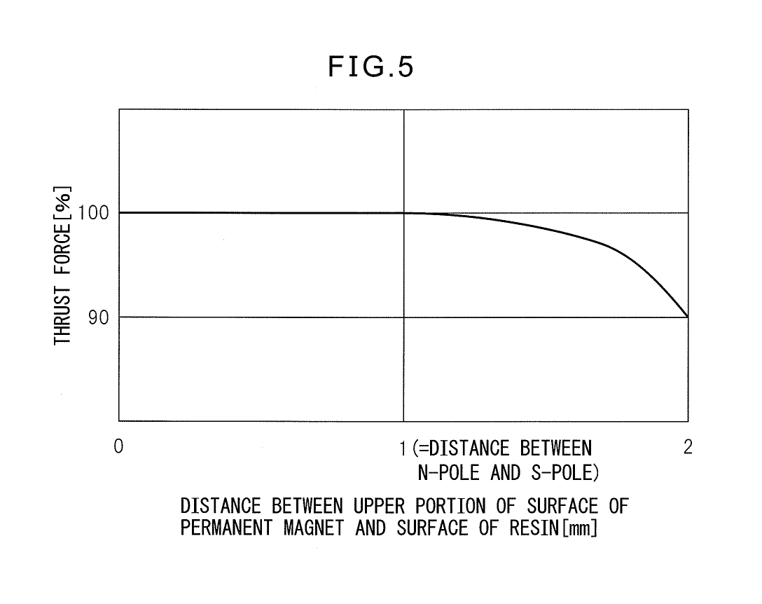

FIG. 5 shows a graph representing the relationship between thrust force of the linear motor and a distance between the upper portion of the surface of the permanent magnet and the surface of resin. In view of residual flux density of a neodymium magnet generally used as a fixed permanent field pole in a linear motor and a BH curve of a magnetic steel sheet on a slider (armature) side, the density of magnetic flux of the linear motor is approximately 1.5 T (Tesla). In this case, a proper gap between the fixed permanent magnetic pole and the slider is equal to or less than 1 mm. When the gap is larger than 1 mm, the thrust force of the motor is decreased as shown in FIG. 5. Further, in view of the magnetic force, it is preferable that the distance between the upper surface of the permanent magnet and the surface of the resin layer is equal to or less than a gap between the permanent magnets of the fixed permanent magnetic field (a gap between adjacent N- and S-magnets, i.e., a width of a spacer 30 which separates adjacent N- and S-magnets as shown in FIG. 1).

Although eight (four pairs of) permanent magnets 20 are arrayed on one iron plate so as to form a set of permanent magnetic poles in the illustrated embodiment, two, three, five or another number of pole pairs of permanent magnets may be used. By arraying a plurality sets of such permanent magnetic poles in a row, a magnetic plate having an arbitrary length (e.g., several tens of centimeters to several meters) can be constituted.

According to the present invention, in the magnetic plate for the linear motor, the strength of a portion of the resin layer having a relatively small thickness can be easily improved. In other words, by arranging the woven cloth on the surface of the permanent magnet when the resin layer is formed on surface of the permanent magnet, the impregnation of resin into the portion having the small thickness can be assisted, and crack resistance of the resin (i.e., resistance to a crack generated by expansion and contraction of the resin due to temperature change) can be improved.

By injecting resin generally in a center of the permanent field poles in relation to an array direction of the permanent magnets, a resin layer may be obtained without mixing air bubbles or the like into the resin.

While the invention has been described with reference to specific embodiments chosen for the purpose of illustration, it should be apparent that numerous modifications could be made thereto, by a person skilled in the art, without departing from the basic concept and scope of the invention.

1. A magnetic plate for a linear motor having permanent magnets constituted by a plurality of pole pairs, the magnetic plate cooperating with an armature having an iron core and a winding wire to form a linear motor, the armature being movable relative to the magnetic plate;
wherein the magnetic plate comprises a resin layer positioned between a surface of the permanent magnet and the armature and on the surface of the permanent magnet; and
wherein a woven cloth, with which resin is impregnated, is arranged between the surface of the permanent magnet and the resin layer, so that the woven cloth covers the surface of the permanent magnet.

2. The magnetic plate as set forth in claim 1, wherein the woven cloth is a glass woven cloth or a carbon fiber woven cloth.

3. The magnetic plate as set forth in claim 1, wherein the resin is epoxy resin or phenol resin.

4. The magnetic plate as set forth in claim 1, wherein each permanent magnet is a rectangular parallelepiped; or, a curve shape obtained by two-dimensionally projecting a surface of each permanent magnet opposed to the armature, in a direction perpendicular to an array direction of the permanent magnets, is represented by a quadric curve, an arc or a hyperbolic cosine function.

5. The magnetic plate as set forth in claim 1, wherein a distance between an upper portion of the surface of the permanent magnet and a surface of the resin layer is equal to or less than 1 mm.

6. The magnetic plate as set forth in claim 1, wherein a distance between an upper portion of the surface of the permanent magnet and a surface of the resin layer is equal to or less than a distance between adjacent magnets of N-pole and S-pole.

7. The magnetic plate as set forth in claim 1, wherein the plurality of pole pairs of permanent magnets are arrayed on one iron plate so as to constitute a set of permanent field poles, and a plurality of sets of permanent field poles are arrayed in a row so as to constitute a magnetic plate for a linear motor.

8. A linear motor comprising the magnetic plate as set forth in claim 1.

9. A method of manufacturing a magnetic plate for a linear motor, having permanent magnets constituted by a plurality of pole pairs, the magnetic plate cooperating with an armature having an iron core and a winding wire to form a linear motor, the armature being movable relative to the magnetic plate; wherein the magnetic plate comprises a resin layer positioned between a surface of the permanent magnet and the armature and on the surface of the permanent magnet; the method comprising the steps of:
arranging a woven cloth between a surface of the resin layer opposed to the armature and the permanent magnet by covering the surface of the permanent magnet with the woven cloth;
positioning the permanent magnet in a mold; and
carrying out resin molding to form the resin layer by injecting resin on the woven cloth so that the injected resin is impregnated with the woven cloth.

10. The method as set forth in claim 9, wherein the woven cloth is adhered to the surface of the permanent magnet when the woven cloth covers the surface of the permanent magnet.

11. The method as set forth in claim 9, wherein the resin is injected from a center point of a permanent field pole in relation to an arraying direction of the permanent magnets.
